(19) United States
(12) Patent Application Publication
(10) Pub. No.: US 2009/0132376 A1
(43) Pub. Date: May 21, 2009

(54) Method for using visible surfaces as advertising surfaces for aerial image and satellite recordings

(76) Inventors: Jorn Kollin, Consrade (DE); Wolfram Sander, Consrade (DE)

Correspondence Address: WALTER OTTESEN, PO BOX 4026, GAITHERSBURG, MD, 20885-4026, US

(21) Appl. No.: 12/289,054

(22) Filed: Oct. 20, 2008

Related U.S. Application Data
(63) Continuation of application No. PCT/DE2007/000748, filed on Apr. 26, 2007.

(30) Foreign Application Priority Data
Apr. 26, 2006 (DE) 10 2006 020 022.5

(51) Int. Cl. G06Q 30/00; G06T 15/00

(52) U.S. Cl. 705/14; 345/419

(57) ABSTRACT

A method utilizes visible surfaces as an advertising surface for aerial image and satellite recordings and is inexpensive while ensuring a representation that is close to reality. This is achieved by a method for utilizing visible surfaces as advertising surfaces for aerial and satellite recordings wherein a virtual advertising carrier is created according to the dimensions of an advertising surface (4) of a real advertising carrier and the created virtual advertising carrier is incorporated into the virtual representation of the real advertising carrier. Such methods are used for utilizing unoccupied visible surfaces and free surfaces, such as rooftops and squares, as advertising surfaces for aerial and satellite recordings.

### CROSS REFERENCE TO RELATED APPLICATIONS

This application is a continuation application of international patent application PCT/DE 2007/000748, filed Apr. 26, 2007, designating the United States and claiming priority from German application 10 2006 020 022.5, filed Apr. 26, 2006, and the entire content of both applications is incorporated herein by reference.

### FIELD OF THE INVENTION

The invention relates to a method for using visible surfaces as advertising surfaces for aerial image and satellite recordings. A virtual space is created from the aerial image and satellite recordings.

### BACKGROUND OF THE INVENTION

A method of the type described above is used for utilizing unused visible surfaces and free spaces, such as roof surfaces and places, as advertising surfaces for aerial image and satellite recordings.

The visible surfaces are all visible outside surfaces of objects and free spaces. These objects include, for example, houses or towers but they also include free spaces such as places, meadows, arable fields and the like.

Aerial image and satellite recordings are used in various programs. Accordingly, applications such as telephone books, route planners and city guides are known, for example, from Google Earth, Microsoft or Go Yellow. A target location is selected via aerial image and satellite recordings and are magnified by zooming until, in the enlarged state, details such as streets and houses are recognizable. The search information such as the sought-after telephone number or the computer travel route are displayed.

Such programs have an ever widening user circle so that they are very interesting for advertising.

Solutions are known wherein the objects, which are imaged on the aerial image and satellite recordings, are characterized by symbols. Behind these symbols, pages of information are stored which can be opened by the user with a mouse click. These data extend from general information such as the name of the company or business resident in the characterized object and its market segment up to specific data as to the company such as number of employees and gross receipts.

However, it is disadvantageous in these solutions that such information is additionally faded into the aerial image and satellite recordings and therefore deteriorates the total view of the image. Furthermore, the symbols are arranged above the objects. In this way, several symbols often lie one atop the other especially in large cities so that a clear allocation is possible only with difficulty.

However, it is above all disadvantageous that, in these solutions, the quality of the aerial image and satellite recordings is deteriorated. The data are not permanently visible because they are not integrated into the aerial image and satellite recordings as they really are, that is, they are not close to reality.

For this reason, it is also known to use roof surfaces as carriers of advertisements. For example, a series of companies have placed their corporate logo on the corporate roofs as an effective advertisement.

It is also known to optically magnify the advertising signature or logo utilizing a concave mirror. Thus, the BMW company has arranged its corporate logo on its corporate roof in Munich across the base surface. The outer periphery of the corporate logo is surrounded by a concave mirror whereby the corporate logo is significantly enlarged in the aerial image and satellite recordings with respect to its dimensions.

However, it is disadvantageous that the rooftop structure is very large. Because of this, this solution is much too expensive in establishing the same and with respect to maintenance against weather. It is also disadvantageous that this rooftop structure can only be changed with great effort. Thus, the rooftop structure cannot, for example, be rotated for a better view. It is also disadvantageous that, when a company changes location, it is expensive to disassemble the rooftop structure on the old corporate location and to assemble the same at the new corporate location.

### SUMMARY OF THE INVENTION

In view of the above, it is an object of the invention to provide a method for utilizing visible surfaces as advertising surfaces for aerial image and satellite recordings which is inexpensive and ensures a display which is close to reality.

The method of the invention is for utilizing visible surfaces as advertising surfaces for aerial image and satellite recordings. The method includes the steps of: providing a virtual advertising carrier in accordance with the measurements of an advertising surface of a real advertising carrier; and, integrating the virtual carrier into a virtual display of the real advertising carrier.

The above method obviates the above-mentioned disadvantages of the state of the art.

When applying the method of the invention, it is advantageous that a virtual advertisement carrier is provided according to the dimensions of an advertising surface of a real advertising carrier and the established virtual advertising carrier is integrated into the virtual display of the real advertisement carrier. For this purpose, aerial image and satellite recordings are digitalized and thereafter are combined via suitable computer programs to a three-dimensional image so that each object point in the three-dimensional image is stored with three position coordinates. Any desired visible surface is used as advertising surface, for example, with a company logo.

Two variations are present. With the first variation, the real advertisement carrier is first built and then photographed. Thereafter, the recordings are digitalized and are thereafter combined to a three-dimensional image via suitable computer programs so that each object point in the three-dimensional image is stored with three position coordinates.

In the second variation, the company logo is three-dimensionally constructed with a suitable computer program. Likewise, each object point of the company logo is stored with three position coordinates.

This three-dimensional image or construction of the company logo is thereafter superposed onto the three-dimensional image with a suitable computer program and is adapted to the roof surface with respect to its dimensions as well as its orientation.

A further advantage in the application of the method of the invention results when at least one visible surface is covered with at least one virtual structure and each structure is provided with an advertising surface for aerial image and satellite recordings. The structure with the advertising surface is incorporated into the aerial image and satellite recordings. In this way, a cost effective advertisement can be applied to visible surfaces of objects and free surfaces. With these advertising surfaces, possible damage to the object (such as roof damage) and ugly spots such as mounds of garbage can be touched up. Furthermore, such virtual image structures with the advertising surfaces are easy to remove so that a corporate relocation is non-problematical. Also, the use of such processed aerial image and satellite recordings is conceivable for navigation systems or cellular telephones.

It is also advantageous when the aerial image and satellite recordings are digitalized and thereafter combined to a three-dimensional image. Each object point in the three-dimensional image is stored with three position coordinates and the advertising surface is virtually three-dimensionally constructed with an advertisement such as a corporate logo. Each object point of the advertisement is stored with three position coordinates. The three-dimensional construction of the advertising surface with the advertisement is superposed onto the three-dimensional image and is adapted with respect to its dimensions as well as with respect to its orientation to the object points of the three-dimensional image. The covered object points of the position coordinates in the three-dimensional image are replaced by the object points of the advertising surface with the advertisement. In this way, three-dimensional animations can be simulated close to reality, for example for a city tour, from the aerial image and satellite recordings utilizing computer technology and this significantly increases the visualization of the objects displayed on the aerial image and satellite recordings.

### BRIEF DESCRIPTION OF THE DRAWINGS

The invention will now be described with reference to the drawings wherein:

FIG. 1 is a schematic of the perspective view of a roof surface having a corporate logo;

FIG. 2 is a schematic of the plan view of the roof surface with the corporate logo;

FIG. 3 is a schematic of the perspective view of an object with the corporate logo on a side surface;

FIG. 4 is a schematic of the perspective view of a free surface with the corporate logo; and,

FIG. 5 is a schematic of the plan view of the free surface with the corporate logo.

### DESCRIPTION OF THE PREFERRED EMBODIMENTS OF THE INVENTION

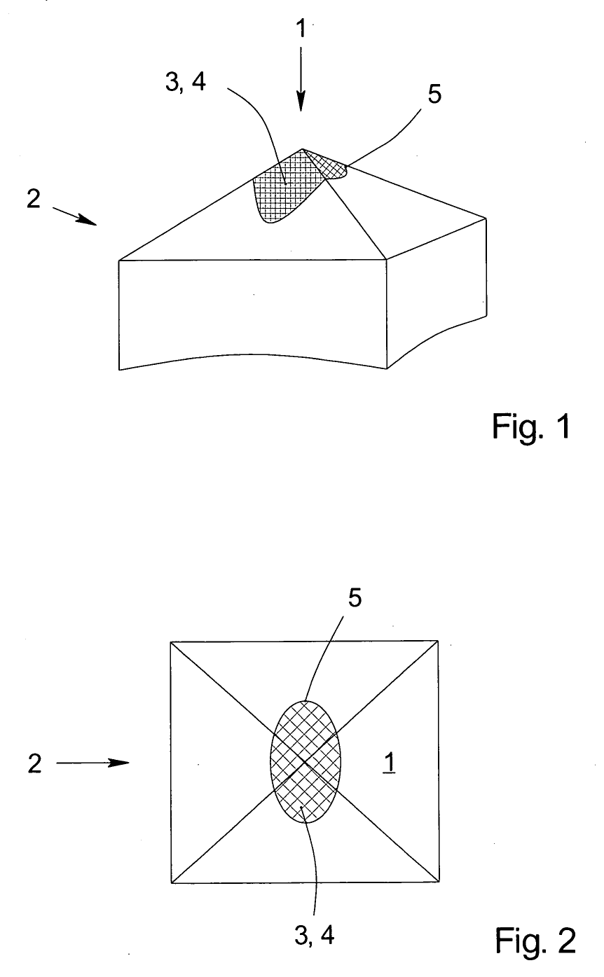

The method of the invention is for using visible surfaces for advertising. Accordingly, the roof surface can be configured as a visible surface 1 of a building 2 with a corporate logo 3 on an advertising surface 4. Here, and corresponding to FIG. 1, the corporate logo 3 is applied over a structure 5 flat on the visible surface 1 so that the real view of the corporate logo 3 results in the plan view of the building 2 in correspondence to FIG. 2.

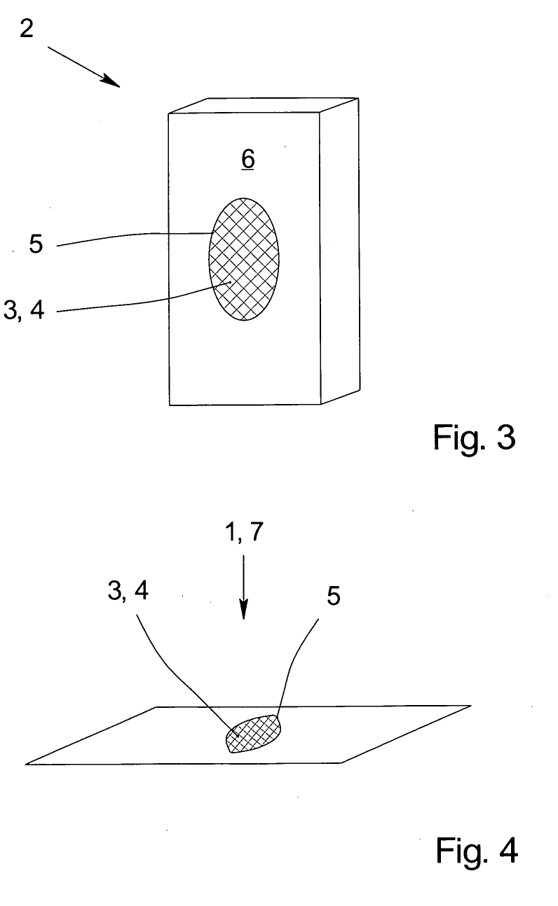

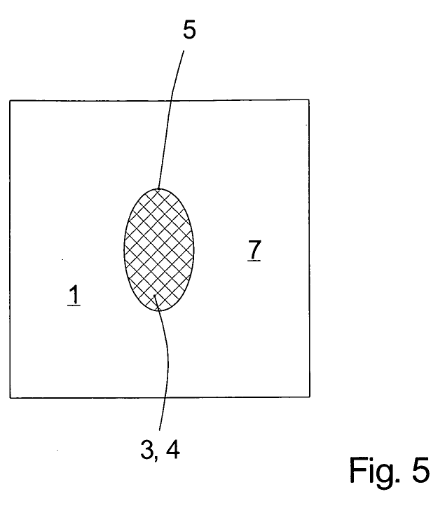

Likewise, the corporate logo 3 can be arranged on at least one side surface 6 of a building 2 as shown in FIG. 3 or on a free surface 7 as shown in FIGS. 4 and 5.

The method of the invention will now be described in greater detail with respect to an embodiment thereof.

The method of the invention proceeds from an untreated aerial image and satellite recording.

While only the plan view of the photographed object is detected with a satellite recording, the exterior side walls of the object are also photographed with the aerial image recording.

These aerial image and satellite recordings are digitalized and thereafter combined to a three-dimensional image with the aid of suitable computer programs. In this way, each object point in the three-dimensional image is stored with three position coordinates.

If a roof surface of a building shown in the image is to be provided with an advertisement such as a corporate logo, then, first, the corporate logo is constructed in three dimensions with a suitable computer program. Each object point of the corporate logo is likewise stored with three position coordinates. This three-dimensional construction of the corporate logo is thereafter superposed onto the three-dimensional image with a suitable computer program and is adapted in its dimensions as well as in its orientation to the roof surface.

When the alignment of the corporate logo on the roof surface is completed, then the object points of the corporate logo lie on a portion of the object points in the three-dimensional image. The object points of the corporate logo as well as the covered object points in the three-dimensional image have the same position coordinates. Thereafter, the three-dimensional construction of the corporate logo is copied into the three-dimensional image. The covered object points in the three-dimensional image are replaced by the object points of the corporate logo.

The three-dimensional image formed in this way now also includes virtual components with the corporate logo in addition to the real components of the object.

It is understood that the foregoing description is that of the preferred embodiments of the invention and that various changes and modifications may be made thereto without departing from the spirit and scope of the invention as defined in the appended claims.

### LIST OF REFERENCE NUMERALS

1 Visible surface
2 Building
3 Corporate logo
4 Advertising surface
5 Structure
6 Side surface
7 Free surface

What is claimed is:

1. A method of utilizing visible surfaces as advertising surfaces for aerial image and satellite recordings, the method comprising the steps of:
creating a virtual advertising carrier in accordance with the measurements of an advertising surface of a real advertising carrier; and,
integrating said virtual carrier into a virtual display of said real advertising carrier.

2. The method of claim 1, comprising the further steps of:
creating a virtual space from said aerial image and satellite recordings;
covering at least one visible surface with at least one virtual structure;
providing said virtual structure with said advertising surface; and,
virtually integrating said virtual structure with said advertising surface into said virtual space.

3. The method of claim 2, comprising the further steps of:
to create said virtual space, digitalizing said aerial image and satellite recordings and then combining said recordings to a three-dimensional image having a plurality of object points; and,
storing each of said object points with three position coordinates.

4. The method of claim 3, comprising the further steps of:
virtually three-dimensionally constructing said advertising surface with an advertisement; and,
storing each object point of said advertisement with three position coordinates.

5. The method of claim 4, comprising the further steps of:
superposing the three-dimensional construction of said advertising surface with said advertisement onto said three-dimensional image;
adapting said three-dimensional construction with respect to the dimensions as well as the orientation thereof to the object points of said three-dimensional image; and,
replacing the covered object points of the position coordinates in said three-dimensional image by the object points of said advertising surface with said advertisement.
